(19) United States
(12) Patent Application Publication
(10) Pub. No.: US 2024/0383073 A1
(43) Pub. Date: Nov. 21, 2024

(54) OSCILLATING LASER WELDING WITH FILLER WIRES FOR JOINTING ALUMINUM ALLOY SHEETS WITH A LARGE GAP THEREBETWEEN

(71) Applicant: BEIJING UNIVERSITY OF TECHNOLOGY, BEIJING (CN)

(72) Inventors: SHIKAI WU, BEIJING (CN); ENYU QI, BEIJING (CN); XUJIAN CUI, BEIJING (CN); JUNCHONG ZHANG, BEIJING (CN); WENBIN QIN, BEIJING (CN)

(21) Appl. No.: 17/631,772

(22) PCT Filed: Jan. 18, 2021
(86) PCT No.: PCT/CN2021/072465

§ 371 Date: Sep. 5, 2023

(30) Foreign Application Priority Data
Oct. 23, 2020 (CN) 202011146991.6

(51) Int. Cl. B23K 26/211; B23K 26/10; B23K 26/14; B23K 26/60; B23K 101/18; B23K 103/10

(52) U.S. Cl. CPC B23K 26/211; B23K 26/10; B23K 26/1464; B23K 26/60; B23K 2101/18; B23K 2103/10

(57) ABSTRACT

An oscillating laser welding with filler wires for jointing aluminum alloy sheets with a large gap therebetween, including the following steps: providing two aluminum alloy sheets first, and reserving a gap (2) and keeping the gap with a constant width between opposite surfaces of the two aluminum alloy sheets to be jointed; providing a laser welding head (1), a wire feeding nozzle (3), and a protective gas nozzle (4) above the gap; presetting a welding start guiding plate (5) at a welding starting end of the gap, forming a molten pool on the welding start guiding plate by a laser beam, and guiding the molten pool to the welding starting end of the gap; and enabling the wire feeding nozzle and the laser welding head to correspond to the gap and travel in the same direction. The aluminum alloy welding wires fill the whole gap after being heated and molten by the laser beam, and the welding of the two aluminum alloy sheets is completed. The melting amount of the aluminum alloy sheets by the laser beam can be reduced as much as possible, so that a dilution rate of a welding joint and generation of a metallurgical reaction brittle phase can be reduced, and the porosity of the joint can further be reduced. Welding of conventional aluminum alloys, aluminum matrix composite materials, and additive-manufactured aluminum alloy sheets can be realized.

### CROSS REFERENCE TO RELATED APPLICATIONS

This patent application claims the benefit and priority of Chinese Patent Application Number 202011146991.6 filed on Oct. 23, 2020, as well as PCT Patent Application Number PCT/CN2021/072465 which was filed on Jan. 18, 2021.

### FIELD OF THE INVENTION

The present disclosure relates to the technical field of welding, and in particular, to an oscillating laser welding with filler wires for jointing aluminum alloy sheets with a large gap therebetween.

### BACKGROUND OF THE INVENTION

As a non-ferrous metal structural material, aluminum alloy is widely used due to its low density, high specific strength, strong corrosion resistance, excellent electrical conductivity and thermal conductivity, and etc. With development of modern science and technology, such as aerospace, energy resources, ocean engineering, and transportation, higher requirements for material performance are provided, and a variety of novel aluminum alloy materials and novel aluminum alloy manufacturing technologies have been developed. There are novel aluminum alloy materials represented by silicon carbide reinforced aluminum matrix composite materials and novel manufacturing technologies represented by a Three-dimensional (3D) printing technology. For example, silicon carbide particle reinforced aluminum matrix composite materials (SiCₚ/Al) are widely applied to the industrial fields, such as aerospace, instruments and apparatuses, and precision machinery, due to their excellent performance, such as high specific rigidity, specific strength, thermal conductivity, dimensional stability, wear resistance, and corrosion resistance. 3D printed AlSi₁₀Mg is used as an ideal modern structural material that can realize lightweight and environment protection of traffic vehicles due to its excellent comprehensive performance, such as good corrosion resistance, fluidity, thermal cracking resistance, and no stress corrosion cracking tendency.

However, jointing among these advanced aluminum alloy materials are inevitably involved in industrial engineering, such as aerospace, instruments and apparatuses or precision machinery. Taking a joint of SiCₚ/Al composite material as an example, the welding manners commonly used around the world include brazing, diffusion welding, resistance welding, arc welding, friction welding, laser welding, electron beam welding, etc. However, introduction of a reinforcement body has a great impact on a welding process due to great differences in physical and chemical properties between a composite material reinforcement phase and a base metal. If base metals are jointed together after being molten through a laser beam by adopting a traditional fusion welding, similar to a laser welding used in an aluminum alloy laser oscillating welding method disclosed in patent document CN107442935A. Taking the SiCₚ/Al composite material as an example, the reinforcement phase SiC in the SiCₚ/Al composite material is easy to cause an interfacial reaction with liquid Al in a molten pool to generate brittle Al₄C₃ and Al₄SiC₄ phases. However, the Al₄C₃ phase is a main reason for the low strength of a joint. Although a solid-phase joint represented by friction stir welding can avoid melting of the base metals to prevent generation of the Al₄C₃ brittle phase, a large number of severely deformed structures are distributed in the base metals because heat affected zones of the base metals are both subjected to heat and mechanical force. Referring to a seam cross section in FIG. 1, formed by a traditional single laser jointing manner, (a) in FIG. 1 is the seam cross section of the SiCₚ/2009Al composite material and the (b) in FIG. 1 is the seam cross section of 3D printed AlSi₁₀Mg. It can be seen from the drawings that the two kinds of materials show large porosity and dense porosity after welding. Furthermore, the solid-phase welding is difficult to be widely applied in a flexible and complex aerospace structural component, due to the defects of its low welding efficiency and limits of welding size and joint form.

### SUMMARY OF THE INVENTION

An objective of the present disclosure is to provide an oscillating laser welding with filler wires for jointing aluminum alloy sheets with a large gap therebetween to solve the above technical problem, which reserves a gap to reduce a dilution rate of the aluminum alloy sheets during welding, so as to avoid generation of porosity defect and metallurgical reaction brittle phase.

To achieve the above objective, the present disclosure provides an oscillating laser welding with filler wires for jointing aluminum alloy sheets with a large gap therebetween. The welding includes the following steps:
clamping step for: providing two aluminum alloy sheets and a plurality of aluminum alloy welding wires with similar material composition to the aluminum alloy sheets, fixing the aluminum alloy sheets to a welding fixture and compressing the two aluminum alloy sheets tightly, and reserving and maintaining a gap with a constant width between opposite surfaces of the two aluminum alloy sheets to be jointed;
welding arrangement step for: arranging a wire feeding nozzle for feeding the aluminum alloy welding wires and a laser welding head for emitting a laser beam above the aluminum alloy sheets after the aluminum alloy sheets are fixed, and applying protective gas to the opposite surfaces to allow the opposite surfaces to be isolated from air during welding, wherein the wire feeding nozzle is close to the gap, and the laser welding head is mounted to align with the wire feeding nozzle; and
welding step for: presetting a guiding plate made of a same material as the aluminum alloy sheets at each of a welding starting end and a welding ending end of the gap; forming a molten pool on the guiding plate by the laser beam and the aluminum alloy welding wires, and moving and guiding the molten pool into the gap, such that the aluminum alloy welding wires are heated and molten by the laser beam to fill all of the gap; having the wire feeding nozzle and the laser welding head travel along the gap, so as to complete welding of the two aluminum alloy sheets.

In some embodiments, a thickness of each aluminum alloy sheet is 1 mm to 3 mm, and the width of the gap is 0.8 mm to 1.4 mm.

In some embodiments, the aluminum alloy sheet is made of a conventional aluminum alloy material, an aluminum matrix composite material, or an aluminum alloy material from 3D printing.

In some embodiments, in the clamping step, grinding surfaces of the aluminum alloy sheet and scrapping off oxide layers on the opposite surfaces, and cleaning and blowing the opposite surfaces before the aluminum alloy sheets are fixed.

In some embodiments, in the welding arrangement step, when the laser welding head is aligned with the wire feeding nozzle, a focal point of the laser beam is aligned with an outer edge of an end portion of an extending end of each aluminum alloy welding wire such that the laser beam is tangent to the aluminum alloy welding wire, and the focal point of the laser beam and upper surfaces of the aluminum alloy sheets are located in a same plane.

In some embodiments, in the welding step, oscillating the laser welding head reciprocally in a direction perpendicular to a traveling direction while having the laser welding head travel along the gap during welding, and wherein an oscillating amplitude of the laser welding head is not greater than the width of the gap.

In some embodiments, an oscillating path of the laser welding head is a circle with a welding seam as a central axis of symmetry, or a shape of a sinusoid with the welding seam as an X axis, or a shape of “∞” with the welding seam as a central axis of symmetry in a welding direction.

In some embodiments, an oscillating path of the laser welding head is in a shape of 8 with a welding seam as a central axis of symmetry in a welding direction, and two circles of the shape of 8 are symmetrical about the welding seam as an axis of symmetry.

Compared with the prior art, the present disclosure achieves the following technical effects:
1. Taking the aluminum alloy sheets made of the SiCₚ/Al composite material as an example: in combination with the characteristics that reinforcement body SiC particles will react with Al matrix to generate Al₄C₃ and Al₄SiC₄ brittle phases after the SiCₚ/Al composite material is molten, a gap with a width is reserved between opposite surfaces of the two aluminum alloy sheets to be jointed. The wire feeding nozzle and the laser welding head correspond to the gap and travel in the same direction, the aluminum alloy welding wires fill the whole gap after being heated and molten through the laser beam so as to connect the two aluminum alloy sheets. The melting amount of the aluminum alloy sheets by the laser beam can be reduced as much as possible during the whole welding process, so as to reduce the dilution rate of the aluminum alloy sheets, and avoid generation of a large amount of brittle phases.
2. For laser welding of the aluminum alloy sheets, a gap with a certain width is reserved between the opposite surfaces of the two aluminum alloy sheets to be jointed for laser welding with filler wires, which overcomes the limitation that the width of a jointing gap of the base metals cannot exceed ½ of the diameter of a spot or 10% of the thickness of the base metals to ensure good welding seam formation in the laser welding in the prior art.
3. During welding, the focal point of the laser beam and the upper surfaces of the aluminum alloy sheets are located in the same plane, an out-of-focus state is zero. Energy utilization rate of the laser beam is greatly improved compared with that in conventional laser brazing. Furthermore, the higher welding speed reduces the weld heat input effectively, and reduces residual stress after welding.
4. The way of providing the guiding plate made of the same material at the welding starting end ensures that a stable molten pool can be formed, and the molten pool is guided into the welding starting end of the gap to prevent a phenomenon that the laser directly passes through the gap and cannot form the molten pool to affect formation of the welding seam.
5. The guiding plates made of the same material as the aluminum alloy sheets are preset at the welding starting end and the welding ending end of the gap respectively; the molten pools are respectively formed on the two guiding plates by the laser beam and the aluminum alloy welding wires first, and the two molten pools are respectively guided into the gap, so as to complete starting and ending spot welding steps that keep a gap structure constant, thereby preventing poor welding quality caused by changes of the gap during welding.
6. In an 8-shaped laser oscillating manner, on one hand, a stirring effect on the molten pools is achieved, so as to accelerate escape of hydrogen and reduce generation of porosity, and on the other hand, through the 8-shaped laser oscillating manner, stable molten pools can be formed to ensure welding formation under the condition that the welding seam has a gap.

### BRIEF DESCRIPTIONS OF THE DRAWINGS

To describe the technical solutions in the embodiments of the present disclosure or in the prior art more clearly, the following briefly describes the accompanying drawings required for describing the embodiments. Apparently, the accompanying drawings in the following description are merely some embodiments of the present disclosure, and those of ordinary skill in the art may still derive other drawings from these accompanying drawings without creative efforts.

FIG. 1 shows seam cross sections of two aluminum alloy materials welded in a conventional laser welding: (a) is a seam cross section of a SiCₚ/2009Al composite material with SiCₚ in a volume percentage of 17%, and (b) is a seam cross section of a 3D printed AlSi₁₀Mg.

FIG. 2 is a schematic diagram of a welding process according to the present disclosure;

FIG. 3 is a schematic diagram showing use of a laser beam in an 8-shaped oscillating manner according to the present disclosure.

FIG. 4 is a seam cross section of a SiCₚ/2009Al composite material welded, with a thickness of 1.6 mm and SiCₚ in a volume percentage of 17% according to the present disclosure.

FIG. 5 is a seam cross section of a 3D printed AlSi₁₀Mg with a thickness of 1.6 mm, welded according to the present disclosure.

FIG. 6 is a seam cross section of a 2198-aluminum-lithium alloy with a thickness of 1.6 mm, welded according to the present disclosure.

FIG. 7 is a welding seam Radiographic Testing (RT) negative picture of the SiCₚ/2009Al composite material with the thickness of 1.6 mm and SiCₚ in the volume percentage of 17%, welded according to the present disclosure: (a) is a welding seam obtained by selecting a 5356-aluminum alloy welding wire; and (b) is a welding seam obtained by selecting a 2319-aluminum alloy welding wire.

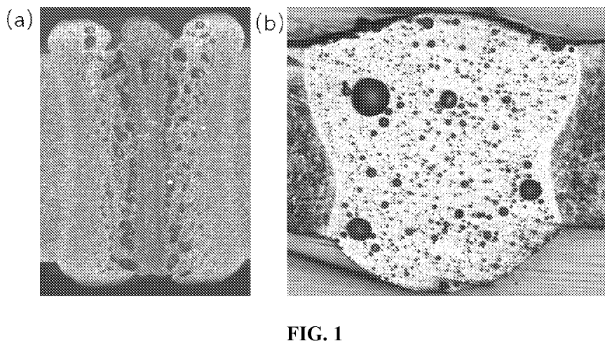

### DETAILED DESCRIPTION OF THE EMBODIMENTS

Technical solutions in the embodiments of the present disclosure will be clearly and completely described herein below with reference to the drawings in the embodiments of the present disclosure. Apparently, the described embodiments are merely part rather than all of the embodiments of the present disclosure. On the basis of the embodiments of the present disclosure, all other embodiments obtained by those of ordinary skill in the art without creative work fall within the scope of protection of the present disclosure.

The present disclosure is used to overcome the defects of the above existing prior art, and provides an oscillating laser welding with filler wires for jointing aluminum alloy sheets with a large gap therebetween, which reserves a gap to reduce a dilution rate of the aluminum alloy sheets during welding, so as to avoid generation of a porosity defect and a metallurgical reaction brittle phase.

In order to make the abovementioned objective, features, and advantages of the present disclosure more apparent and more comprehensible, the present disclosure is further described in detail below with reference to the drawings and specific implementations.

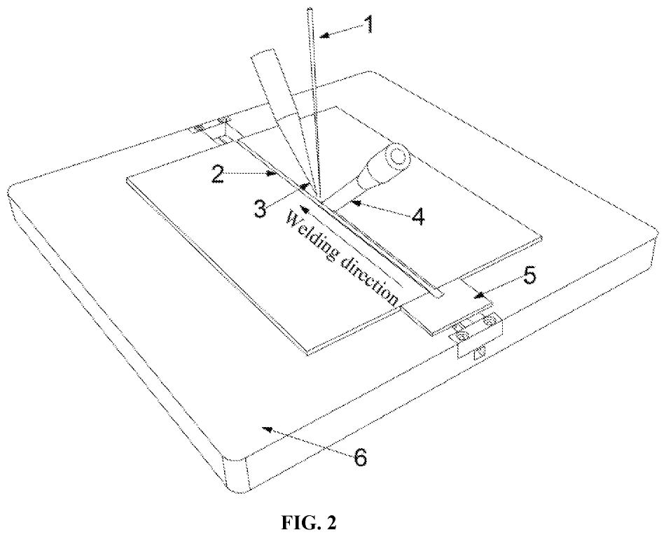

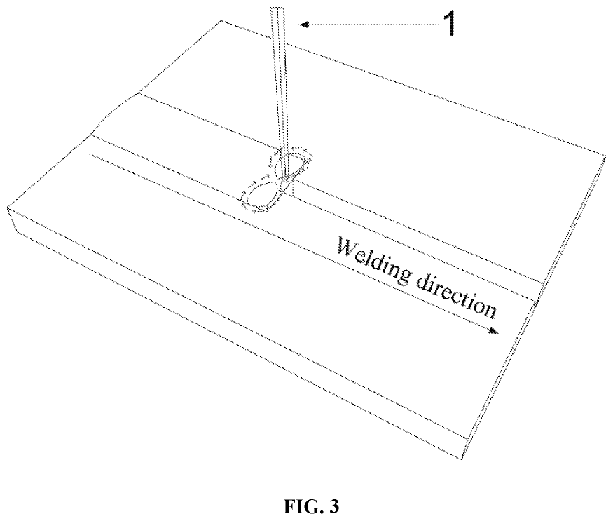

As shown in FIG. 2 to FIG. 3, the present embodiment provides an oscillating laser welding with filler wires for jointing aluminum alloy sheets with a large gap therebetween. The method includes the following steps:
S1: sheet clamping: two aluminum alloy sheets and a plurality of aluminum alloy welding wires with similar material composition to the aluminum alloy sheets are provided, a thickness of each aluminum alloy sheet is 1 mm to 3 mm. Particularly, for an aluminum alloy material with a poor self-fusion welding effect, such as a SiCₚ/Al composite material, a 3D printed AlSi₁₀Mg, aluminum alloy welding wires may adopt 5356-aluminum alloy welding wires or 2319-aluminum alloy welding wires. The aluminum alloy sheets are fixed to a welding tool. Preferably, the two aluminum alloy sheets are butted. After a gap with a certain width is reserved and maintained between opposite surfaces of the two aluminum alloy sheets to be jointed, the aluminum alloy sheets are clamped and compressed tightly through a clamp arranged on a welding back protection fixture. In some embodiments, the width is 0.8 mm to 1.4 mm. In order to form a stable gap, in some embodiments, a plurality of feeler gauges with a same width as the gap between the two opposite surfaces are provided, clamped between the two opposite surfaces before fixing the aluminum alloy sheets with the clamp, and taken away after the aluminum alloy sheets are fixed.

As a preferred implementation mode of the present disclosure, in order to ensure welding effectiveness of the aluminum alloy sheets, before fixing the aluminum alloy sheets, the aluminum alloy sheets are subjected to surface grinding and oxide layers on the opposite surfaces are scraped off first, then the opposite surfaces are scrubbed by acetone to remove moisture, oil, and debris from the opposite surfaces, and then the surfaces are blown by compressed air in order to avoid the oxides or other impurities on the opposite surfaces from affecting quality of formed welding seam.
S2, welding arrangement: after the aluminum alloy sheets are fixed, a protective gas is applied to the opposite surfaces of the aluminum alloy sheets, so as to ensure that the opposite surfaces are isolated from air during welding. Preferably, a gas feeding nozzle used for applying the protective gas is arranged at a position close to the gap. The gas feeding nozzle includes a gas outlet arranged directly opposite to the welding seam, so as to communicate the protective gas during welding. The protective gas covers the opposite surfaces through the gas outlet, so as to form effective protection on subsequent overall formation of the welding seam.

Meanwhile, a wire feeding nozzle for feeding the aluminum alloy welding wires and a laser welding head for emitting a laser beam are respectively arranged above the aluminum alloy sheets. The wire feeding nozzle is close to the gap, and the laser welding head corresponds to the wire feeding nozzle. Preferably, the wire feeding nozzle is arranged in front of the laser welding head in a welding direction, which facilitates continuous wire feeding of the wire feeding nozzle and will not be interfered by the laser welding head. In addition, the gas feeding nozzle is arranged behind the laser welding head and keeps the gas outlet directly facing a spot, then the protective gas can be generated during welding so as to prevent quality of the welding seam from reducing caused by oxygen, and the gas feeding nozzle is arranged behind the laser welding head, so as to cool the formed welding seam during welding. Preferably, when the laser welding head and the wire feeding nozzle are adjusted, a focal point of the laser beam is aligned with an outer edge of a bottom end of an aluminum alloy welding wire to achieve a state in which the laser beam is tangent to the aluminum alloy welding wire, which facilitates full melting of the aluminum alloy welding wire to form a molten pool.
S3, welding process: in order to ensure that a stable molten pool can be formed, to guide the molten pool into the welding starting end of the gap, and prevent occurrence of a phenomenon that the laser directly passes through the gap and cannot form the molten pool to affect the formation of the welding seam, a welding start guiding plate made of the same material as the aluminum alloy sheets is preset at the welding starting end of the gap. After the wire feeding nozzle and the laser welding head are debugged, welding is performed on the welding start guiding plate and the molten pool is formed on the welding start guiding plate first, and the molten pool is guided to the welding starting end of the gap, so that the gap is filled continuously by the molten pool, so as to avoid the laser beam from passing through the gap to affect the welding quality in a subsequent welding process.

In addition, the focal point of the laser beam and the upper surfaces of the aluminum alloy sheets are located in a same plane, which is in a zero defocus state, so that the energy utilization rate of the laser beam is greatly improved compared with that in a defocused beam state in conventional laser brazing. Meanwhile, the welding speed is fast and the weld heat input is also effectively reduced, residual stress after welding can be reduced.

As a preferred implementation mode of the present disclosure, a welding end guiding plate made of the same material as the aluminum alloy sheets is preset at the welding ending end of the gap. After the molten pool is guided to the welding starting end of the gap, spot welding is performed on the welding end guiding plate to form the molten pool and the molten pool is guided to the welding ending end, so as to form welding spots at two ends of the gap to maintain a stable gap structure, which prevents quality changes of the welding caused by the change of the gap during welding. Preferably, the thickness of the welding start guiding plate and the thickness of the welding end guiding plate are the same as those of the aluminum alloy sheets, so that the molten pools will not jump in span during propulsion, thereby ensuring smoothness of the molten pools entering the gap.

After the molten pool is guided into the welding starting end of the gap, the wire feeding nozzle and the laser welding head correspond to the same gap and travel in the same direction. The aluminum alloy welding wires are heated by the laser beam and molten to fill the whole gap, so as to connect the two aluminum alloy sheets and complete the welding of the two aluminum alloy sheets. Preferably, while the laser welding head is traveling in the welding direction, the laser welding head is oscillated left and right in the direction perpendicular to the traveling direction, and the oscillating amplitude of the laser welding head is not greater than the gap between the two opposite surfaces to be jointed, so that the focal point of the laser beam is avoided from falling onto the aluminum alloy sheets, which leads to excessive melting of the aluminum alloy sheets and increased dilution rate of the aluminum alloy sheets, and the quality of the welding seam is affected. The oscillating path of the laser welding head is a circle that takes a welding seam as a central axis of symmetry, or a sinusoids shape that takes a welding seam as an X axis, or a shape of ∞ that takes a welding seam as a central axis of symmetry in a welding direction, or a shape of 8 that takes a welding seam as a central axis of symmetry. The structure presented by the shape of 8 includes two circular structures which are symmetrically distributed on the two sides of the welding seam. In the structure presented by the shape of ∞, the left end and the right end of the shape of ∞ are arranged in sequence in the welding direction. Each of the two circular structures included in the ∞ shape form a structure with two semicircles symmetrically distributed on the two sides of the welding seam by taking the welding seam as a central axis of symmetry. By using an 8-shaped laser oscillating manner, on one hand, a stirring effect on the molten pool is achieved, so as to accelerate escape of hydrogen, which can effectively prevent generation of defects, such as cracks and porosity, during welding of aluminum alloy; and on the other hand, through the 8-shaped laser oscillating manner, the stable molten pool can be formed to ensure welding and forming under the condition that a welding seam has a gap. In addition, preferably, in order to further ensure the welding quality, when the oscillating path of the laser welding head is 8-shaped, for the aluminum alloy sheets with the thickness of 1.6 mm, the welding speed is 4.8 m/min, the wire feeding speed is 9.6 m/min, the laser power is 3200 W, which form optimal parameters when the 8-shaped oscillating is adopted. Precision welding of the welding seam is realized, and a crack-free high-quality welding seam with good surface forming is obtained. For example, the tensile strength of the welded SiCₚ/2009Al composite material with the thickness of 1.6 mm and SiCₚ in volume percentage of 17% can reach 212 MPa; and for the 3D printed AlSi₁₀Mg with the thickness of 1.6 mm, a breaking strength of the welded joint can reach ductile fracture strength of the base metal, through a tensile test.

In one word, an objective of the present disclosure is to provide the oscillating laser welding method with filler wires through a reserved gap. Movement of the spot from the laser welding head can be controlled during welding, so as to realize different laser oscillating manners. A welded surface has no defects such as an undercut and a crack, and the welding seam has less porosity and no hole defect. Furthermore, taking the aluminum alloy sheets made of the SiCₚ/Al composite material as an example: in combination with the characteristics that reinforcement body SiC particles will react with an Al matrix to generate Al₄C₃ and Al₄SiC₄ brittle phases after the SiCₚ/Al composite material is molten, controlling the melting amount of the base metal within a certain range and reducing the dilution rate of the base metal so as to further reduce generation of brittle phases and improve performance of the joint, effectively improves connecting strength of the aluminum alloy sheets welded by laser and overcomes a limit that a width of a gap in a traditional laser welding cannot exceed ½ of a diameter of a spot or 10% of a thickness of the base metal. In a specific operation, the welding method of the present disclosure can weld a gap of 1.4 mm for the aluminum alloy sheets of 1.6 mm, and reduce requirement on welding assembling accuracy.

The oscillating laser welding with filler wires of the present disclosure is described in detail below in combination with specific embodiments. Specific components in different embodiments are as follows:

### Embodiment 1

The SiCₚ/2009Al composite material with the thickness of 1.6 mm and SiCₚ volume percentage of 17% is selected as test plates to be welded, and welding is performed according to the above oscillating laser welding method with filler wires for the aluminum alloy sheets abutted with a large gap. The welding parameters are as follows: the welding wires selected as 5356-aluminum alloy welding wires, the 8-shaped oscillating path of the laser welding head, the oscillating amplitude of 1.0 mm, the oscillating frequency of 200 Hz, the gap of 1.0 mm, the laser power of 3200 W, the welding speed of 4.8 m/min, and the wire feeding speed of 11.2 m/min.

### Embodiment 2

The SiCₚ/2009Al composite material with the thickness of 1.6 mm and the SiCₚ in a volume percentage of 17% is selected as test plates to be welded, and welding is performed according to the above oscillating laser welding method with filler wires for the aluminum alloy sheets abutted with a large gap. The welding parameters are as follows: the welding wires selected as 5356-aluminum alloy welding wires, the 8-shaped oscillating path of the laser welding head, the oscillating amplitude of 1.0 mm, the oscillating frequency of 200 Hz, the gap of 1.2 mm, the laser power of 3200 W, the welding speed of 4.8 m/min, and the wire feeding speed of 11.2 m/min.

### Embodiment 3

The SiCₚ/2009Al composite material with the thickness of 1.6 mm and the SiCₚ volume percentage of 17% is selected as test plates to be welded, and welding is performed according to the above oscillating laser welding method with filler wires for the aluminum alloy sheets abutted in a large-gap. The welding parameters are as follows: the welding wires selected as 2319-aluminum alloy welding wires, the 8-shaped oscillating path of the laser welding head, the oscillating amplitude of 1.0 mm, the oscillating frequency of 200 Hz, the gap of 1.0 mm, the laser power of 3500 W, the welding speed of 4.8 m/min, and the wire feeding speed of 9.6 m/min.

### Embodiment 4

The 3D printed AlSi₁₀Mg sheets with the thickness of 1.6 mm are selected as test plates to be welded, and welding is performed according to the above oscillating laser welding method with filler wires for the aluminum alloy sheets abutted with a large gap. The welding parameters are as follows: the welding wires selected as 5356-aluminum alloy welding wires, the 8-shaped oscillating path of the laser welding head, the oscillating amplitude of 1.0 mm, the oscillating frequency of 200 Hz, the gap of 1.0 mm, the laser power of 3200 W, the welding speed of 4.8 m/min, and the wire feeding speed of 9.6 m/min.

### Embodiment 5

2198-aluminum-lithium alloy with the thickness of 1.6 mm is selected as test plates to be welded, and welding is performed according to the above oscillating laser welding method with filler wires for the aluminum alloy sheets abutted with a large gap. The welding parameters are as follows: the welding wires selected as 5356-aluminum alloy welding wires, the 8-shaped oscillating path of the laser welding head, the oscillating amplitude of 1.0 mm, the oscillating frequency of 200 Hz, the gap of 1.0 mm, the laser power of 3200 W, the welding speed of 4.8 m/min, and the wire feeding speed of 9.6 m/min.

### Embodiment 6

2198-aluminum-lithium alloy with the thickness of 1.6 mm is selected as test plates to be welded, and welding is performed according to the above oscillating laser welding method with filler wire for the aluminum alloy sheets abutted with a large gap. The welding parameters are as follows: the welding wires selected as 2319-aluminum alloy welding wires, the 8-shaped oscillating path of the laser welding head, the oscillating amplitude of 1.0 mm, the oscillating frequency of 200 Hz, the gap of 1.0 mm, the laser power of 3200 W, the welding speed of 4.8 m/min, and the wire feeding speed of 9.6 m/min.

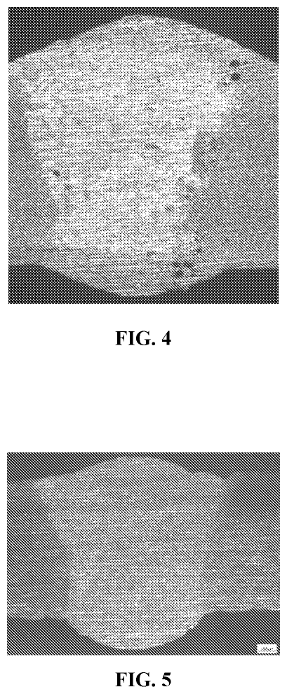

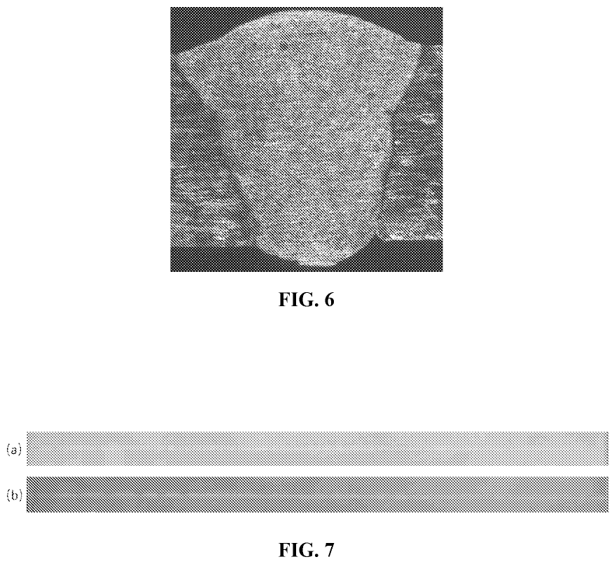

FIGS. 4 to 6 are cross sections of the welding seams of Embodiments 2, 3, and 5 of the present disclosure. It can be reflected from the drawings that the welding method of the present disclosure is suitable for welding the sheets made of the SiCₚ/2009Al composite material, the 3D printed AlSi₁₀Mg, and the 2198-aluminum-lithium alloy. FIG. 7 can reflect that the SiCₚ/2009Al composite material welded under the welding parameters of Embodiment 1 and Embodiment 3 does not have a large porosity with the diameter of greater than 0.1 mm and aggregated porosity.

All adaptive changes made according to actual demands are within the scope of protection of the present disclosure.

In the present disclosure, specific examples are applied to illustrate the principle and implementation mode of the present disclosure. The description of the above embodiment is only used to help understand the method and core idea of the present disclosure. Meanwhile, for those of ordinary skill in the art, there will be changes in the specific implementation mode and scope of application according to the idea of the present disclosure. In conclusion, the content of the present description shall not be construed as a limitation to the present disclosure.

What is claimed is:

1. An oscillating laser welding with filler wires for jointing aluminum alloy sheets with a large gap therebetween, comprising following steps:
clamping step for: providing two aluminum alloy sheets and a plurality of aluminum alloy welding wires with similar material composition to the aluminum alloy sheets, fixing the aluminum alloy sheets to a welding fixture and compressing the two aluminum alloy sheets tightly, and reserving and maintaining a gap with a constant width between opposite surfaces of the two aluminum alloy sheets to be jointed;
welding arrangement step for: arranging a wire feeding nozzle for feeding the aluminum alloy welding wires and a laser welding head for emitting a laser beam above the aluminum alloy sheets after the aluminum alloy sheets are fixed, and applying protective gas to the opposite surfaces to allow the opposite surfaces to be isolated from air during welding, wherein the wire feeding nozzle is close to the gap, and the laser welding head is mounted to align with the wire feeding nozzle; and
welding step for: presetting a guiding plate made of a same material as the aluminum alloy sheets at each of a welding starting end and a welding ending end of the gap; forming a molten pool on the guiding plate by the laser beam and the aluminum alloy welding wires, and moving and guiding the molten pool into the gap, such that the aluminum alloy welding wires are heated and molten by the laser beam to fill the gap; having the wire feeding nozzle and the laser welding head travel along the gap, so as to complete welding of the two aluminum alloy sheets.

2. The oscillating laser welding according to claim 1, wherein a thickness of each aluminum alloy sheet is 1 mm to 3 mm, and the width of the gap is 0.8 mm to 1.4 mm.

3. The oscillating laser welding according to claim 1, wherein the aluminum alloy sheet is made of a conventional aluminum alloy material, an aluminum matrix composite material, or an aluminum alloy material from 3D printing.

4. The oscillating laser welding according to claim 3, further comprises: in the clamping step, grinding surfaces of the aluminum alloy sheet and scrapping off oxide layers on the opposite surfaces, and cleaning and blowing the opposite surfaces before the aluminum alloy sheets are fixed.

5. The oscillating laser welding according to claim 4, wherein in the welding arrangement step, when the laser welding head is aligned with the wire feeding nozzle, a focal point of the laser beam is aligned with an outer edge of an end portion of an extending end of each aluminum alloy welding wire such that the laser beam is tangent to the aluminum alloy welding wire, and the focal point of the laser beam and upper surfaces of the aluminum alloy sheets are located in a same plane.

6. The oscillating laser welding according to claim 5, further comprises: in the welding step, oscillating the laser welding head reciprocally in a direction perpendicular to a traveling direction while having the laser welding head travel along the gap during welding, and wherein an oscillating amplitude of the laser welding head is not greater than the width of the gap.

7. The oscillating laser welding according to claim 6, wherein an oscillating path of the laser welding head is a circle with a welding seam as a central axis of symmetry, or a shape of a sinusoid with the welding seam as an X axis, or a shape of “∞” with the welding seam as a central axis of symmetry in a welding direction.

8. The oscillating laser welding according to claim 6, wherein an oscillating path of the laser welding head is in a shape of 8 with a welding seam as a central axis of symmetry in a welding direction, and two circles of the shape of 8 are symmetrical about the welding seam as an axis of symmetry.
